(19) United States
(12) Patent Application Publication
(10) Pub. No.: US 2016/0180804 A1
(43) Pub. Date: Jun. 23, 2016

(54) REFRESH RATE CONTROL USING SINK REQUESTS

(71) Applicant: Intel Corporation, Santa Clara, CA (US)

(72) Inventor: Nobuyuki Suzuki, Portland, OR (US)

(73) Assignee: INTEL CORPORATION, Santa Clara, CA (US)

(21) Appl. No.: 14/581,559

(22) Filed: Dec. 23, 2014

(51) Int. Cl. G09G 5/00

(52) U.S. Cl. CPC G09G 5/006; G09G 2340/0435

(57) ABSTRACT

A method for controlling refresh rates is described herein. The method includes sending, via a sink interface controller, a video data transfer request packet, the data transfer request packet to include a refresh rate capability of the display device. The method also includes receiving, via the sink interface controller, an acknowledge response packet. The method further includes receiving, via the sink interface controller, a burst of video data. The method also further includes sending, via the sink interface controller, an acknowledge response packet in response to receiving the burst of video data.

### TECHNICAL FIELD

The present invention relates generally to computer displays. More specifically the present invention relates to techniques for controlling frame refresh rates of computer displays.

### BACKGROUND

Display resolution in smartphones, tablets, and PC platforms, among others, is increasing in both size and resolution. Because such displays typically rely on AC power, the power consumed by displays rises proportionally as display resolution increases. Thus, device displays are increasingly a main source of power consumption in modern day computing.

### BRIEF DESCRIPTION OF THE DRAWINGS

FIG. 1 is a block diagram illustrating an example computing device that can be used to refresh a display device;

FIG. 2 is a block diagram illustrating an example system that can be used to refresh a display device;

FIG. 3 is a communication diagram of an example system providing for display burst data transfer communication when a refresh is started according to the techniques described herein;

FIG. 4 is a communication diagram of an example system providing for display burst data transfer communication when a FIFO is not full according to the techniques described herein;

FIG. 5 is a communication diagram of an example system providing for display burst data transfer communication when a FIFO is full according to the techniques described herein;

FIG. 6 is a communication diagram of an example system providing for display burst data transfer communication when a data transfer is resumed according to the techniques described herein;

FIG. 7 is a communication diagram of an example system providing for display burst data transfer communication when a frame of video data transfer has completed according to the techniques described herein;

FIG. 8 is a communication diagram of an example system providing for display burst data transfer communication when data transfer is resumed with a time delay according to the techniques described herein;

FIG. 9 is a process flow diagram illustrating an example method that depicts computing device functionality for display burst data transfer;

FIG. 10 is a process flow diagram illustrating an example method that depicts display device functionality for display burst data transfer; and

FIG. 11 is a block diagram showing computer readable media that store code for discovery of devices.

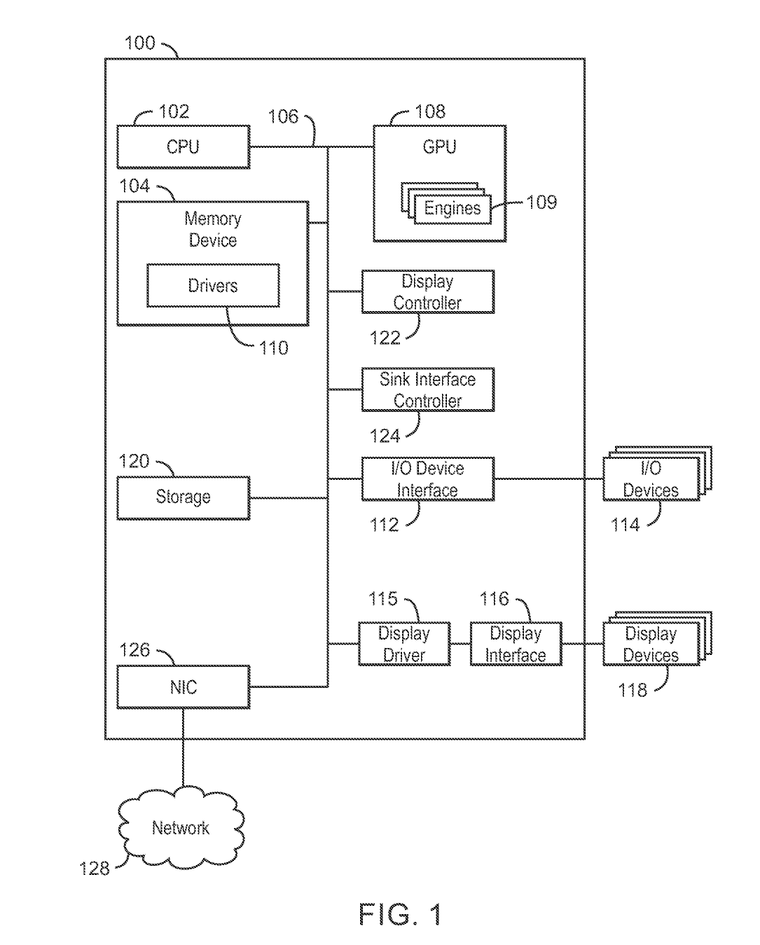

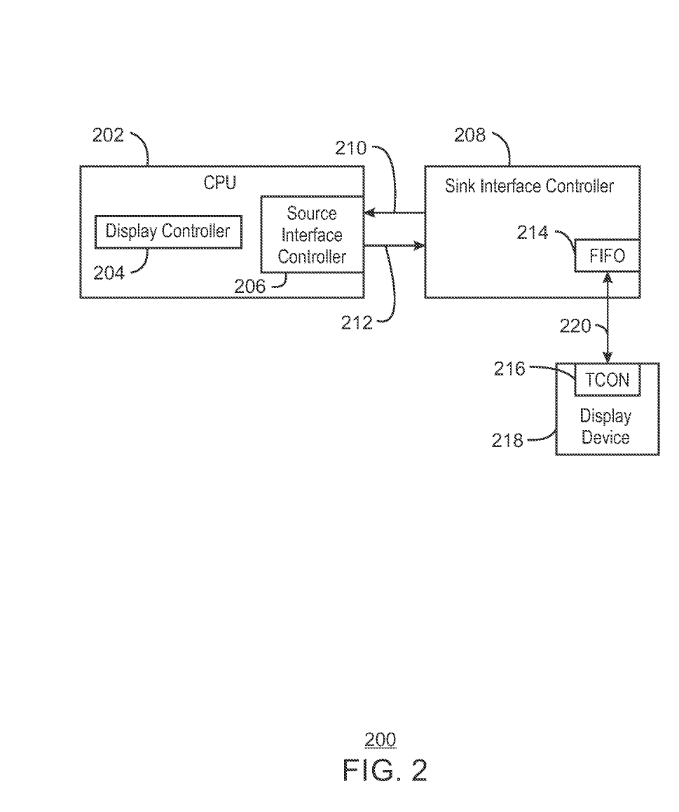

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

As described above, the display electronics power rises proportionally as display resolution increases. One method of reducing the amount of power used by an electronic display is to reduce the refresh rate of the display. However, when a display controller changes the refresh rate, the refresh rate reduction can cause screen flicker that is unhealthy for users of the display. For example, screen flicker may cause eye strain and/or headaches. Moreover, some displays may use dynamic refresh rate change adapting to a display screen pattern or data profile in order to reduce power consumption. For example, power saving features may change the refresh rate or even use a refresh mechanism internal to a panel. Techniques for communicating and controlling the refresh rate between a CPU display controller and a display device are provided herein. The techniques allow changing refresh rate using a sink interface module. Thus, techniques described herein provide energy savings while preventing screen flicker failure. In some examples, the techniques may be used to reduce power used in mobile displays. However, the techniques may also be applied to wired digital display interfaces (wired DDIs).

Some embodiments may be implemented in one or a combination of hardware, firmware, and software. Some embodiments may also be implemented as instructions stored on a computer readable medium, which may be read and executed by a computing platform to perform the operations described herein. A computer readable medium may include any mechanism for storing or transmitting information in a form readable by a machine, e.g., a computer. For example, a computer readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment”, “one embodiment”, “some embodiments”, “various embodiments”, or “other embodiments” means that a particular feature, structure, or characteristic described in connection with the embodiments is included in at least some embodiments, but not necessarily all embodiments, of the inventions. The various appearances of “an embodiment”, “one embodiment or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can”, or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram illustrating an example computing device that can be used as a node for discovery of devices. The computing device 100 may be, for example, a laptop computer, desktop computer, tablet computer, mobile device, or server, among others. The computing device 100 may include a central processing unit (CPU) 102 that is configured to execute stored instructions, as well as a memory device 104 that stores instructions that are executable by the CPU 102. The CPU 102 may be coupled to the memory device 104 by a bus 106. Additionally, the CPU 102 can be a single core processor, a multi-core processor, a computing cluster, or any number of other configurations. Furthermore, the computing device 100 may include more than one CPU 102. The memory device 104 can include random access memory (RAM), read only memory (ROM), flash memory, or any other suitable memory systems. For example, the memory device 104 may include dynamic random access memory (DRAM).

The computing device 100 may also include a graphics processing unit (GPU) 108. As shown, the CPU 102 may be coupled through the bus 106 to the GPU 108. In some cases, the GPU 108 is embedded in the CPU 102. In other cases, the GPU 108 may be a discrete component relative to the CPU 102. The GPU 108 may include a cache, and can be configured to perform any number of graphics operations within the computing device 100. The GPU 108 may be configured to perform any number of graphics operations within the computing device 100. For example, the GPU 108 may be configured to render or manipulate graphics images, graphics frames, videos, or the like, to be displayed to a user of the computing device 100. Displaying image data may be carried out by one or more engines 109 of the GPU 108, a display driver 115, a display interface 116, and the like.

The memory device 104 can include random access memory (RAM), read only memory (ROM), flash memory, or any other suitable memory systems. For example, the memory device 104 may include dynamic random access memory (DRAM). The memory device 104 may include device drivers 110 that are configured to execute the instructions for device discovery. The device drivers 110 may be software, an application program, application code, or the like.

The CPU 102 may also be connected through the bus 106 to an input/output (I/O) device interface 112 configured to connect the computing device 100 to one or more I/O devices 114. The I/O devices 114 may include, for example, a keyboard and a pointing device, wherein the pointing device may include a touchpad or a touchscreen, among others. The I/O devices 114 may be built-in components of the computing device 100, or may be devices that are externally connected to the computing device 100. In some examples, the memory 104 may be communicatively coupled to I/O devices 114 through direct memory access (DMA).

The CPU 102 may also be linked through the bus 106 to a display interface 116 configured to connect the computing device 100 to a display device 118. The display device 118 may include a display screen that is a built-in component of the computing device 100. The display device 118 may also include a computer monitor, television, or projector, among others, that is internal to or externally connected to the computing device 100. In some examples, the display device 118 includes a timing controller that can include an internal clock oscillator. The oscillator can be used to manage display device refresh with video data. In some examples, the display device 118 can also include a sink interface controller that includes a FIFO to receive video data to be displayed. For example, the FIFO can be of any suitable size, such as anywhere from four kilobytes to ten megabytes in size or more.

The computing device also includes a storage device 120. The storage device 120 is a physical memory such as a hard drive, an optical drive, a thumbdrive, an array of drives, or any combinations thereof. The storage device 120 may also include remote storage drives.

The computing device 100 may also include a network interface controller (NIC) 126. The NIC 126 may be configured to connect the computing device 100 through the bus 106 to a network 128. The network 128 may be a wide area network (WAN), local area network (LAN), or the Internet, among others. In some examples, the device may communicate with other devices through a wireless technology. For example, Bluetooth® or similar technology may be used to connect with other devices.

The computing device 100 may also include a display controller 122. The display controller 122 may be implemented as logic, at least partially comprising hardware logic. In other cases, the display controller 122 may be implemented as a portion of software stored in the storage device 104, as software or firmware instructions of the display driver 115, the display interface 116, the engines 109 of the GPU 108, the CPU 102, any other suitable controller, or any combination thereof. In yet other cases, the display controller 122 may be implemented as electronic logic, at least partially comprising hardware logic, to be carried out by electronic circuitry, circuitry to be carried out by an integrated circuit, and the like. The display controller 122 may be configured to operate independently, in parallel, distributed, or as a part of a broader process. In yet other cases, the display controller 122 may be implemented as a combination of software, firmware, hardware logic, and the like. In some examples, the display controller 122 may be used to receive a video transfer request packet and send an acknowledge response packet to a sink interface controller 124.

In some examples, the sink interface controller 124 may be included inside display device 118. The display controller 122 can send the video burst and receive a second acknowledge response packet from the sink interface controller 124. The sink interface controller 124 may be used to send a video transfer request packet to the display controller 122. The sink interface module 124 can receive an acknowledge response and video burst in response to the request packet. The sink interface controller 124 can also send an acknowledge response to the video burst.

In some examples, a video burst includes video data to be sent at a full speed of a physical layer link of the system. In some examples, the sink interface controller 124 may include a First In, First Out (FIFO) data buffer, the FIFO to receive the video burst from the display controller 122 and send it to a display device 118. In some examples, the sink interface controller 124 may include a line buffer or an output laches. For example, the line buffer or output laches may receive the video burst from the display controller 122 and send it to a display device. In some examples, the sink interface module may be a sink interface controller. The display controller 122 may include a source interface controller of a central processing unit (CPU).

The block diagram of FIG. 1 is not intended to indicate that the computing device 100 is to include all of the components shown in FIG. 1. Rather, the computing system 100 can include fewer or additional components not illustrated in FIG. 1, such as sensors, power management integrated circuits, additional network interfaces, and the like. The computing device 100 may include any number of additional components not shown in FIG. 1, depending on the details of the specific implementation. Furthermore, any of the functionalities of the CPU 102 may be partially, or entirely, implemented in hardware and/or in a processor. For example, the functionality of the display controller 122 and the sink interface controller 124 may be implemented with an application specific integrated circuit, in logic implemented in a processor, in logic implemented in a specialized graphics processing unit, or in any other device.

FIG. 2 is a block diagram illustrating an example system 200 that can be used to refresh a display device. In FIG. 2, the example system 200 includes a CPU 202 including a display controller 204 and source interface controller 206. The source interface controller 206 is connected to sink interface controller 208 via uplink 210 and downlink 212. The sink interface controller 208 includes First In, First Out (FIFO) data buffer 214. The FIFO data buffer 214 is connected to a timing controller (TCON) 216 of display device 218 via connection 220. In some embodiments, the sink interface controller 208 and FIFO 214 can also be included in display device 218.

In embodiments, sink interface controller 208 may send a request for additional video data via uplink 210. In some examples, the request includes display refresh rate. For example, the refresh rate may be 60 Hz or any suitable refresh rate. In response to the video data request, the source interface controller 206 can send bursts of video data via downlink 212. A burst, as used herein, is a unit of video data. For example, a video frame can be split into and sent as one or more bursts of video data. In some examples, the uplink 210 and downlink 212 can be an eDP main link PHY operating in dual simplex. However, any suitable physical layer with bi-directional capability and a threshold bandwidth support can be used. For example, MIPI D-PHY or M-PHY may also be used. In some examples, a link can be established using clock recovery and a symbol lock.

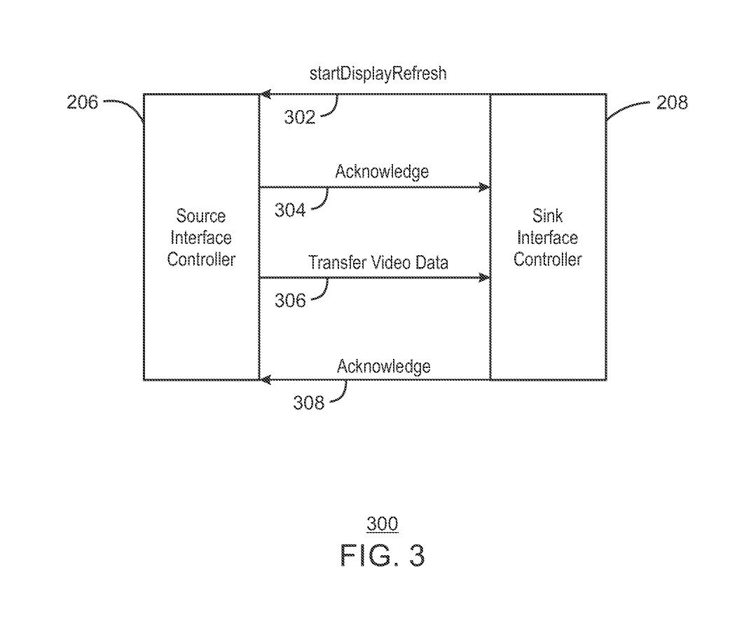

In some examples, the bursts of video data can be stored in a FIFO data buffer 214 of the sink interface controller 208. Alternatively, the bursts of video data can be stored in a line buffer or output laches of the sink interface controller 208. The size of the bursts can be negotiated as an interface initialization before any display refresh begins. The bursts of video data can then be used to refresh a display one frame at a time according to techniques described in FIGS. 3-8 below.

FIG. 3 is a communication diagram of an example system 300 providing for display burst data transfer communication when a refresh is started according to the techniques described herein. In FIG. 3, the example system 300 includes a source interface controller 206 and a sink interface controller 208. A startDisplayRefresh request 302 is indicated by arrow from sink interface controller 208 to source interface controller 206. An acknowledge response 304 is indicated by an arrow from source interface controller 206 to sink interface controller 208. A transfer of video data 306 is indicated by an arrow from source interface controller 206 to sink interface controller 208. A second acknowledge response 308 is indicated by arrow from sink interface controller 208 to source interface controller 206.

In example system 300, the sink interface controller 208 can start a frame refresh. For example, the sink interface controller 208 can send a startDisplayRefresh request packet 302 to the source interface controller 206. In response to receiving the startDisplayRefresh request packet 302, the source interface controller 206 can send an acknowledge response 304. For example, the acknowledge response may be a data packet that is sent back to the sink interface controller 208. After sending the acknowledge response, the source interface controller 206 can send a burst of video data 306. In some examples, a video burst can be sent at a full speed of the physical link that it travels through. In response to receiving the burst of video data 306, the sink interface controller 208 can send an acknowledge response to source interface controller 206. Thus, a burst of video data 306 is received by the sink interface controller 208. In some examples, the burst of video data can be stored in a FIFO of the sink interface controller 208. The sink interface controller 208 may then request additional bursts of video data.

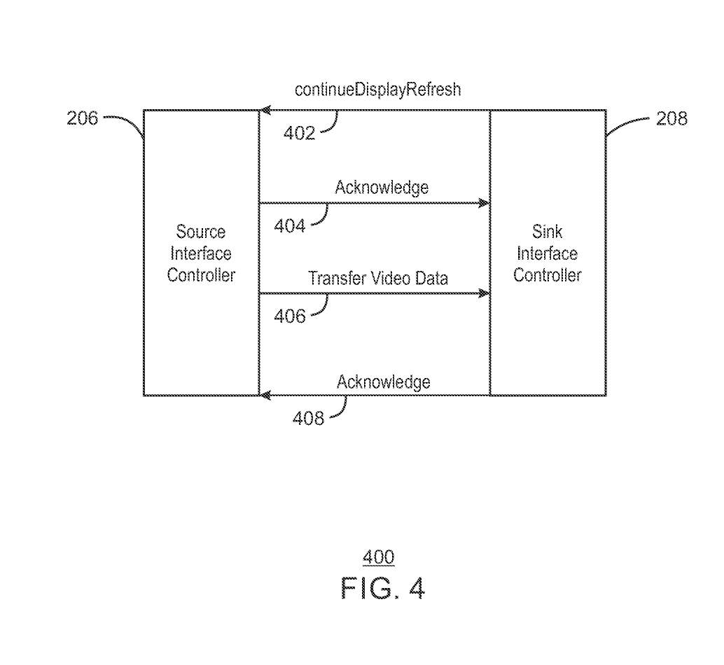

FIG. 4 is a communication diagram of an example system 400 providing for display burst data transfer communication when a FIFO is not full according to the techniques described herein. The example system 400 includes a source interface controller 206 and a sink interface controller 208. A continueDisplayRefresh request 402 is indicated by arrow from sink interface controller 208 to source interface controller 206. An acknowledge response 404 is indicated by an arrow from source interface controller 206 to sink interface controller 208. A transfer of video data 406 is indicated by an arrow 306 from source interface controller 206 to sink interface controller 208. A second acknowledge response 408 is indicated by arrow from sink interface controller 208 to source interface controller 206.

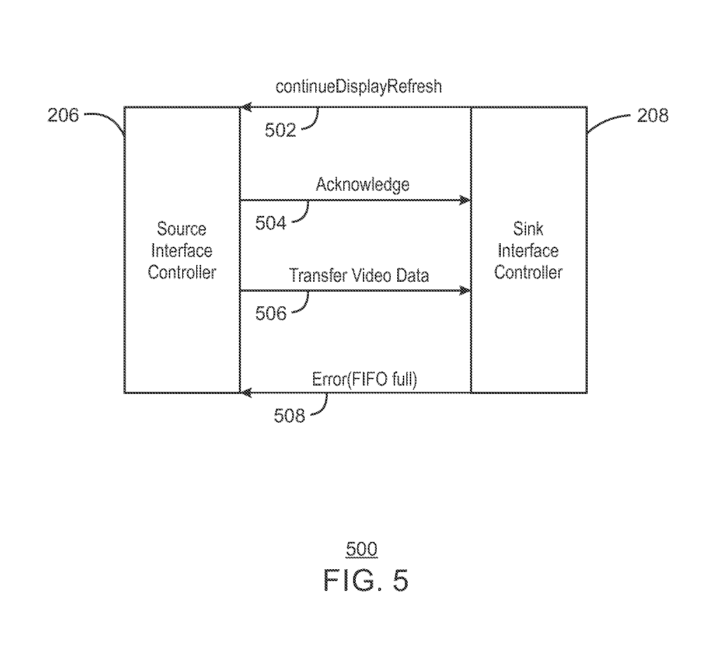

In example system 400, the FIFO of sink interface controller 208 is not full. Thus, the sink interface controller 208 may continue to request additional bursts of data to finish a full frame refresh. In response to each request for additional bursts of data 402, the source interface controller may send an acknowledge response packet 402 and a burst of video data 406. The sink interface controller can likewise send an acknowledge response packet in response to receiving the burst of video data 406. The sink interface controller 208 may request additional bursts of video data in this manner until the FIFO of the sink interface controller 208 becomes full. When the FIFO is full, then the display refresh communication may be suspended as described in FIG. 5 below.

FIG. 5 is a communication diagram of an example system 500 providing for display burst data transfer communication when a FIFO is full according to the techniques described herein. The example system 500 includes a source interface controller 206 and a sink interface controller 208. A continueDisplayRefresh request 502 is indicated by arrow from sink interface controller 208 to source interface controller 206. An acknowledge response 504 is indicated by an arrow from source interface controller 206 to sink interface controller 208. A transfer of video data 506 is indicated by an arrow from source interface controller 206 to sink interface controller 208. A FIFO full error response 508 is indicated by arrow from sink interface controller 208 to source interface controller 206.

In example system 500, the sink interface controller 208 has sent requests 502 for additional bursts of video data, and received an acknowledge response 504 and a burst of video data 506. However, rather than sending an acknowledge response packet as in FIG. 4, the sink interface controller 208 instead sends an error response 508 indicating that the FIFO of sink interface controller 208 is full.

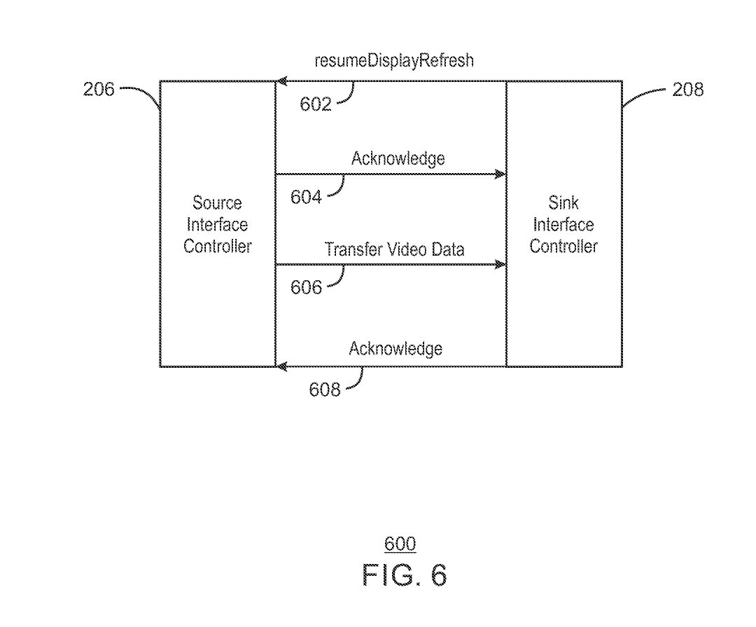

In some examples, bursts of video data in the FIFO may sent to a timing controller of a display device and used to refresh the display device. In this way, space is created for additional bursts of video data in the FIFO. For example, ponce the amount of video data in the FIFO is less than a threshold determined inside the sink interface controller 208, then the burst video data transfer may resume as described in detail in FIG. 6 below.

FIG. 6 is a communication diagram of an example system 600 providing for display burst data transfer communication when a data transfer is resumed according to the techniques described herein. The example system 600 includes a source interface controller 206 and a sink interface controller 208. A resumeDisplayRefresh request 602 is indicated by an arrow from sink interface controller 208 to source interface controller 206. An acknowledge response 604 is indicated by an arrow from source interface controller 206 to sink interface controller 208. A transfer of video data 606 is indicated by an arrow from source interface controller 206 to sink interface controller 208. A second acknowledge response 608 is indicated by arrow from sink interface controller 208 to source interface controller 206.

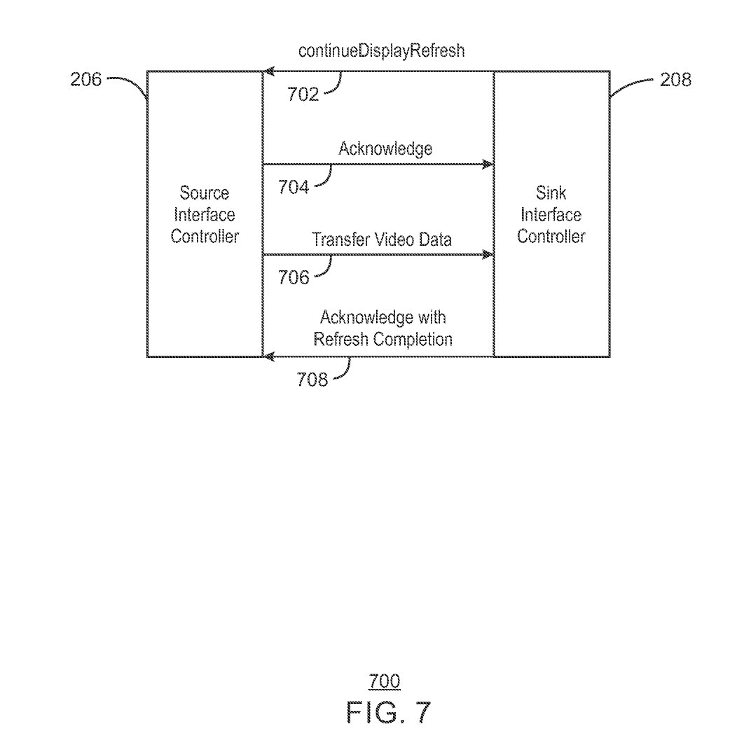

In the example system 600, the sink interface controller 208 has detected that the amount of data in the FIFO has fallen below a threshold amount. The sink interface controller thus sends a request for additional bursts of video data in a resumeDisplayRefresh 602. The source interface controller 206 then responds with an acknowledge packet 604 and a burst of video data 606 as before the suspension of FIG. 5. In some examples, a cycle of suspension and resuming of video data bursts may be continued according to FIGS. 5-6 until an entire frame of video data is completed. When the last burst of video data to complete a frame is received, the system can respond as in FIG. 7.

FIG. 7 is a communication diagram of an example system 700 providing for display burst data transfer communication when a frame of video data transfer has completed according to the techniques described herein. The example system 700 includes continueDisplayRefresh 702 request is indicated by an arrow from sink interface controller 208 to source interface controller 206. An acknowledge response 704 is indicated by an arrow from source interface controller 206 to sink interface controller 208. A transfer of video data 706 is indicated by an arrow from source interface controller 206 to sink interface controller 208. A second acknowledge with refresh completion response 708 is indicated by arrow from sink interface controller 208 to source interface controller 206.

In the example of system 700, sink interface controller 208 sends another request for additional video data continueDisplayRefresh packet 702. The source interface controller 206 can again respond with an acknowledge packet 704 and a burst of video data 706. However, in the example of system 700, the sink interface controller 208 detects that a frame refresh has been completed. For example, the sink interface controller 208 may detect that a frame refresh has completed by counting the total amount of the received data since the last startDisplayPacket is issued and compare the total amount of received data with the pre-programmed required data amount for one display refresh. The sink interface controller 208 then accordingly sends an acknowledge packet with refresh completion 708. The display device can be refreshed with additional frames according to the techniques described in FIGS. 3-7.

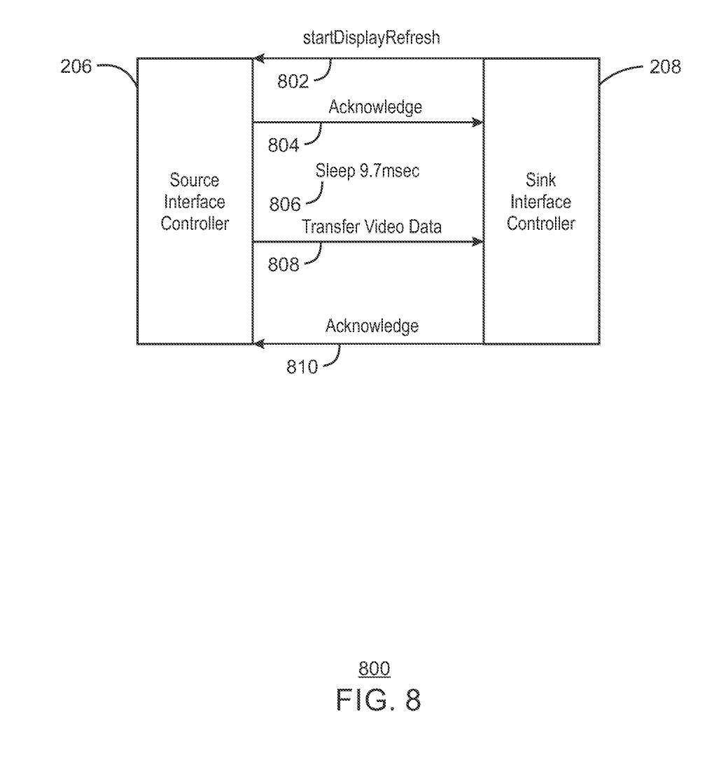

In some examples, a display device may be able to perform at a lower refresh rate. For example, the display device may be able to operate at 40 Hz rather than 60 Hz. The source interface controller 206 can build in a short delay or sleep time, in order to synchronize with the reduced frame rate as described in FIG. 8 below.

FIG. 8 is a communication diagram of an example system 800 providing for display burst data transfer communication when data transfer is resumed with a time delay according to the techniques described herein. In FIG. 8, the example system 800 includes a source interface controller 206 and a sink interface controller 208. A startDisplayRefresh request 802 is indicated by an arrow from sink interface controller 208 to source interface controller 206. An acknowledge response 804 is indicated by an arrow from source interface controller 206 to sink interface controller 208. A transfer of video data 808 is indicated by an arrow from source interface controller 206 to sink interface controller 208. A second acknowledge response 810is indicated by arrow from sink interface controller 208 to source interface controller 206.

In the example system 800, the sink interface controller 208 sends a video data request startDisplayRefresh 802 as in FIG. 3 above. However, a lower refresh rate may be included in a display capability in the data request 802. Or a CPU may decide to slow down the refresh rate based on other processing parameters including, but not limited to, parameters such as battery life or pre-processed image data stored in the storage system or the GPU, For example, a refresh rate of 40 Hz may be supported by the display device rather than 60 Hz. The source interface controller 206 similarly sends an acknowledge packet 804 in response to the video data request 802. In example system 800, the source interface controller 206 may then sleep 806 for a predetermined interval of time before sending sink interface control 208 a burst of video data 808. For example, the interval can be 9.7 milliseconds for a refresh rate change from 60 Hz to 40 Hz. In some examples, the display TCON is designed such that it will not start the display refresh, but extend the blanking interval when FIFO is empty before the next display frame refresh is started. A blanking interval, as used herein, refers the internal time between the previous display refresh and the next display refresh.

In some examples, using the sleep 806 mechanism in the source interface controller 206, the CPU display controller can synchronize the video data transfer start to the display internal refresh start. For example, a display device may use Panel Self-Refresh (PSR) of an Embedded DisplayPort (eDP) interface to save power. The panel of a display device may have an integrated frame buffer in which to store a copy of a current frame being displayed on a screen. For example, the integrated frame buffer may be included inside a timing controller of the display device. When the screen is static, the display device can receive video frames from an internal frame buffer rather than from the computing devices GPU. Thus, the GPU and the CPU of the computing system may power down resulting in saved power. However, when an action causes the image on the screen to no longer be static, then synchronization issues may arise. For example, one synchronization issue may be tearing when the CPU updates the display integrated frame buffer. Tearing, as used herein, refers to a condition where a part of a screen shows a new screen image updated from a CPU, and where the rest of the screen shows an old screen image from an integrated frame buffer. The present techniques can be used to synchronize the video data transfer start of the updated image with the internal refresh start of the panel. In this manner, power may be saved while preventing synchronization issues from arising.

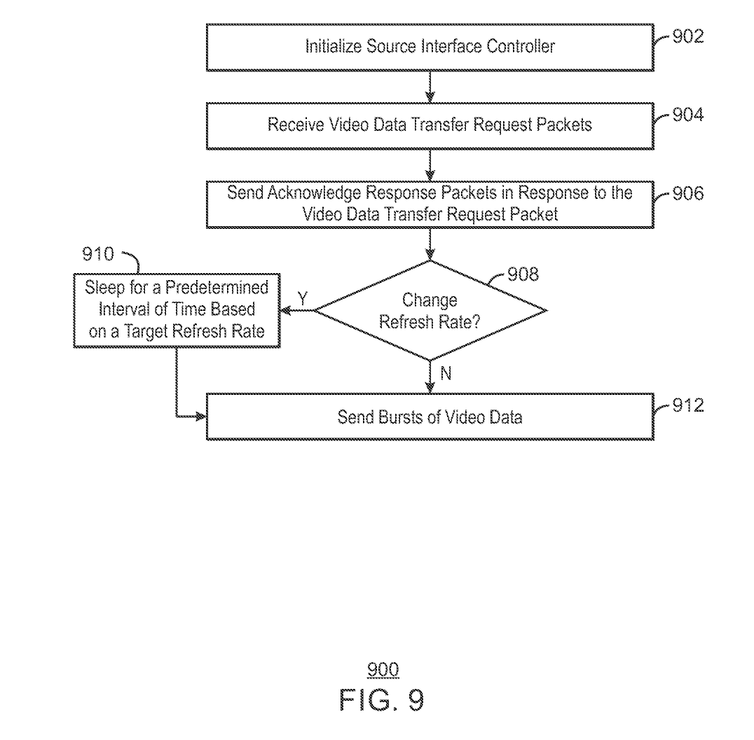

FIG. 9 is a process flow diagram illustrating an example method 900 that depicts computing device functionality for display burst data transfer. The example method of FIG. 9 and can be executed by the source interface controller 206 of CPU 202 in FIG. 2.

At block 902, the CPU 202 initializes the source interface controller 206. In some examples, the size of a burst of video data can be negotiated during the initialization of the source interface controller 206. For example, the size of a burst can depend on factors such as bandwidth.

At block 904, the source interface controller 206 receives video data transfer request packets. In some examples, the video transfer request packets can include a range of refresh rates. For example, the range of refresh rates may be a range of refresh rates that a display device is capable of operating without screen flickering.

At block 906, the source interface controller 206 sends acknowledge response packets in response to the video data transfer request packet.

At block 908, the source interface controller 206 determines whether the next frame refresh rate should be changed or not. For example, the decision can be made by a new target refresh rate contained in the video transfer request packet from the sink controller, or the CPU based on other processing parameters, not limited but, such as a battery life or the pre-processed image data stored in the storage system or the GPU. If the video data transfer request packet does not contain a new target refresh rate, then the source interface controller 206 proceeds to send a burst of video data as described in block 912. If the video data transfer request packet does contain a new target refresh rate, then the source interface controller 206 proceeds to sleep for a predetermined interval of time as described in block 910 below.

At block 910, the source interface controller 206 sleeps for a predetermined interval of time based on a target refresh rate. For example, the target refresh rate may be a rate that is lower than a previous rate. A display device may operate at 60 Hz, for example, and have a target refresh rate of 40 Hz. By operating at a lower refresh rate, battery resources may be saved via less power consumption at the display device.

At block 912, the source interface controller 206 sends bursts of video data. For example, the bursts of video data may be segments of a full frame of video to be displayed on the display device. In some examples, bursts of video may be sent using blocks 904-910 until the FIFO is filled or a frame is complete.

This process flow diagram is not intended to indicate that the blocks of the method 900 are to be executed in any particular order, or that all of the blocks are to be included in every case. Further, any number of additional blocks not shown may be included within the method 900, depending on the details of the specific implementation.

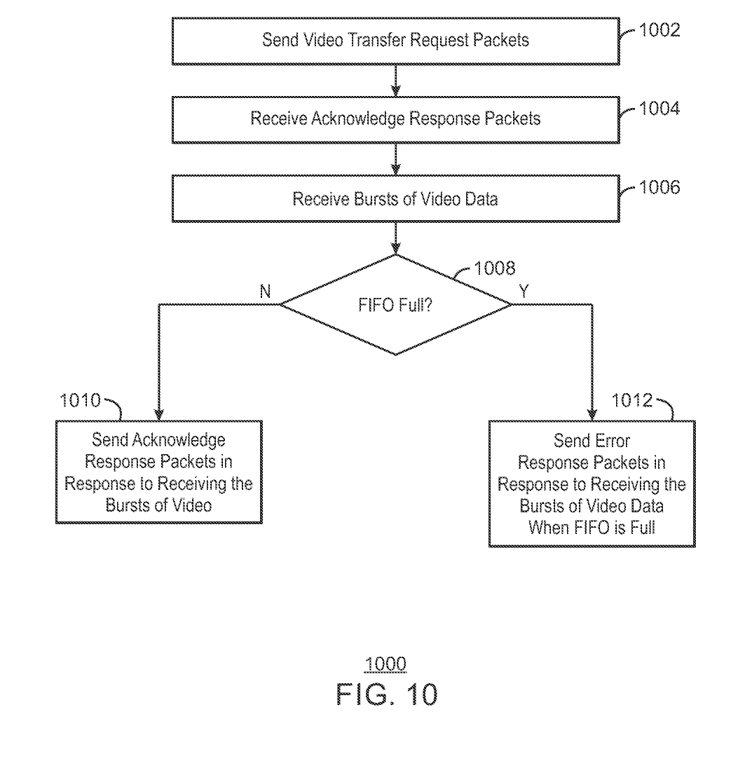

FIG. 10 is a process flow diagram illustrating an example method 1000 that depicts display device functionality for display burst data transfer. The example method of FIG. 10 and can be executed by the sink interface controller 208 of FIG. 2.

At block 1002, the sink interface controller 208 sends video transfer request packets. In some examples, the data transfer request packet to include a refresh rate capability of the display device. For example, the refresh rate capability can include a range of refresh rates that a display device may use without producing screen flicker.

At block 1004, the sink interface controller 208 receives acknowledge response packets. For example, the acknowledge response packets may indicated that a video transfer request packet has been received and that a burst of video data will follow. In some examples, there may then be a sleep for the CPU to adjust the refresh rate. The sync controller can hold the display refresh start until a first video burst data is received such that the synchronization between the CPU display controller and the display TCON is recovered. In this way, a seamless video data update can be realized.

At block 1006, the sink interface controller 208 receives bursts of video data. For example, the bursts of video data may be parts of a video frame to be refreshed on a display. In some examples, the bursts may be stored inside a FIFO and sent to a display device timing controller once the FIFO is full.

At block 1008, the sink interface controller 208 determines whether the FIFO is full. If the FIFO is full, then the sink interface controller 208 sends an error response packet as described in block 1012 below. If the FIFO is not full, then the sink interface controller 208 sends an acknowledge response packet as described in block 1010 below.

At block 1010, the sink interface controller 208 sends acknowledge response packets in response to receiving the bursts of video data. For example, the acknowledge response packets can indicate that a burst was successfully received. In some examples, the acknowledge packets may indicate other events as well. For example, errors may be indicated as in block 1010 below.

At block 1012, the sink interface controller 208 sends error response packets in response to receiving the bursts of video data when FIFO is full. In some examples, the error response packet can suspend further burst video data transfer. For example, the sink interface controller 208 may suspend requests for further bursts of video data until the FIFO is no longer full. In some examples, the sink interface controller 208 can send an additional video data transfer request packet when the FIFO is no longer full to resume the burst video data transfer.

In some examples, the display device can receive video frames from an internal frame buffer to display a static image. For example, the internal frame buffer can be part of the timing controller of the display device. In some examples, the sink interface controller 208 sends an additional video data transfer request to resume receiving bursts of video data via the sink interface controller. The video data transfer start can be synchronized with a display internal refresh start to make the transition from using video data frame from the internal buffer to the using video data from the FIFO smoother. In some examples, the techniques described herein can be used to allow for dynamically changing refresh rates smoothly.

This process flow diagram is not intended to indicate that the blocks of the method 1000 are to be executed in any particular order, or that all of the blocks are to be included in every case. Further, any number of additional blocks not shown may be included within the method 1000, depending on the details of the specific implementation.

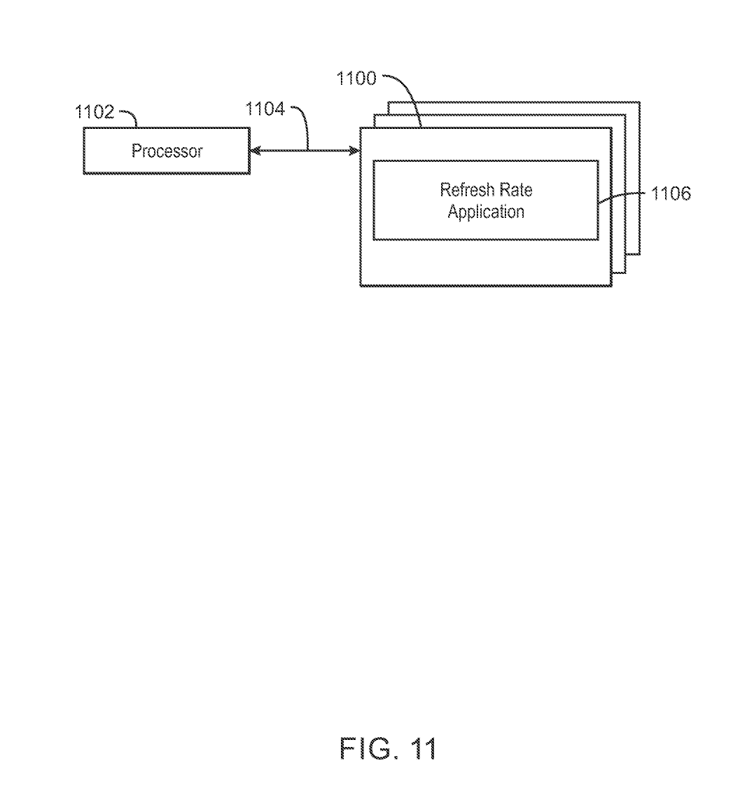

FIG. 11 is a block diagram showing computer readable media 1100 that store code for discovery of devices. The computer readable media 1100 may be accessed by a processor 1102 over a computer bus 1104. Furthermore, the computer readable medium 1100 may include code configured to direct the processor 1102 to perform the methods described herein. In some embodiments, the computer readable media 1100 may be non-transitory computer readable media. In some examples, the computer readable media 1100 may be storage media. However, in any case, the computer readable media do not include transitory media such as carrier waves, signals, and the like.

The block diagram of FIG. 11 is not intended to indicate that the computer readable media 1100 are to include all of the components shown in FIG. 11. Further, the computer readable media 1100 may include any number of additional components not shown in FIG. 11, depending on the details of the specific implementation.

The various software components discussed herein may be stored on one or more computer readable media 1100, as indicated in FIG. 11. For example, a refresh rate application 1106 may be configured to cause a display controller to receive, via a processor, a video data transfer request packet. In some examples, the refresh rate application 1106 may cause the display controller to send, via the processor, an acknowledge response packet in response to the video data transfer request packet. The refresh rate application 1106 may cause the display controller to send, via the processor, a burst of video data. A refresh rate application 1106 may be configured to cause a display controller to send a video data transfer request packet. In some examples, the data transfer request packet may include a refresh rate capability of the display device. The refresh rate application 1106 may also be configured to cause a display controller receive an acknowledge response packet.

In some examples, the refresh rate application 1106 may initialize a source controller interface. For example, the refresh rate application 1106 may be configured to negotiate the data size of the burst of video data during the initialization. The refresh rate application 1106 can also include instructions to sleep for a predetermined interval of time based on a target refresh rate. In some examples, the refresh rate application 1106 can include instructions to synchronize a video data transfer start to a display internal refresh start. The refresh rate application 1106 may also include instructions to resume a video data transfer.

The block diagram of FIG. 11 is not intended to indicate that the computer readable media 1100 is to include all of the components shown in FIG. 11. Further, the computer readable media 1100 may include any number of additional components not shown in FIG. 11, depending on the details of the specific implementation.

Example 1 is a system for controlling refresh rates. The system includes a sink interface controller to send a video transfer request packet. The sink interface controller is to receive an acknowledge response and video burst in response to the request packet. The sink interface controller is to send an acknowledge response to the video burst. The system also includes a display controller to receive the video transfer request packet and send an acknowledge response packet to the first module. The display controller to also send the video burst and receive a second acknowledge response packet.

Example 2 incorporates the subject matter of Example 1. In this example, the video burst includes video data to be sent at a full speed of a physical layer link.

Example 3 incorporates the subject matter of Examples 1-2. In this example, the first module further includes a First In, First Out (FIFO) data buffer, the FIFO to receive the video burst from the sink interface controller and send it to a display device.

Example 4 incorporates the subject matter of Examples 1-3. In this example, the sink interface controller further includes a line buffer or output laches, the line buffer or output laches to receive the video burst from the display controller and send it to a display device.

Example 5 incorporates the subject matter of Examples 1-4. In this example, the display controller to send a video burst via the source interface controller of a central processing unit (CPU).

Example 6 incorporates the subject matter of Examples 1-5. In this example, the display controller to send a video burst via the source interface controller of a graphics processing unit (GPU).

Example 7 incorporates the subject matter of Examples 1-6. In this example, the system includes a mobile device.

Example 8 incorporates the subject matter of Examples 1-7. In this example, the display controller to send a video burst via the source interface controller of a central processing unit (CPU).

Example 9 incorporates the subject matter of Examples 1-8. In this example, the display controller to send a video burst via the source interface controller of a graphics processing unit (GPU).

Example 10 incorporates the subject matter of Examples 1-9. In this example, the system includes a mobile device display.

Example 11 is a method for controlling refresh rates. The method includes sending, via a sink interface controller, a video data transfer request packet, the data transfer request packet to include a refresh rate capability of the display device. The method includes receiving, via the sink interface controller, an acknowledge response packet. The method also includes receiving, via the sink interface controller, a burst of video data. The method includes sending, via the sink interface controller, an acknowledge response packet in response to receiving the burst of video data.

Example 12 incorporates the subject matter of Example 11. In this example, the acknowledge response packet including a refresh completion notification when a frame of video data has been received.

Example 13 incorporates the subject matter of Examples 11-12. In this example, the method includes receiving additional bursts of video data and sending an error response packet when a FIFO in the sink interface controller is full, the error response packet to suspend further burst video data transfer.

Example 14 incorporates the subject matter of Examples 11-13. In this example, the method includes sending an additional video data transfer request packet when the FIFO is no longer full to resume the burst video data transfer.

Example 15 incorporates the subject matter of Examples 11-14. In this example, the method includes receiving video frames from an internal frame buffer to display a static image.

Example 16 incorporates the subject matter of Examples 11-15. In this example, the method includes sending an additional video data transfer request to resume receiving bursts of video data via the sink interface controller, the video data transfer start to be synchronized with a display internal refresh start.

Example 17 incorporates the subject matter of Examples 11-16. In this example, the method includes dynamically changing refresh rates.

Example 18 incorporates the subject matter of Examples 11-17. In this example, the method includes initializing a source controller interface.

Example 19 incorporates the subject matter of Examples 11-18. In this example, the method includes negotiating a data size of the burst of video data.

Example 20 incorporates the subject matter of Examples 11-19. In this example, the method includes synchronize a video data transfer start to a display internal refresh start.

Example 21 is a computer readable medium for controlling refresh rates. The computer readable medium includes instructions stored therein that, in response to being executed on a computing device, cause the computing device to receive, via a processor, a video data transfer request packet. The instructions also cause the computing device to send, via the processor, an acknowledge response packet in response to the video data transfer request packet. The instructions also further cause the computing device to send, via the processor, a burst of video data.

Example 22 incorporates the subject matter of Example 21. In this example, the computer readable medium includes instructions to initialize a source controller interface.

Example 23 incorporates the subject matter of Examples 21-22. In this example, the computer readable medium includes instructions to negotiate the data size of the burst of video data.

Example 24 incorporates the subject matter of Examples 21-23. In this example, the computer readable medium includes instructions to sleep for a predetermined interval of time based on a target refresh rate.

Example 25 incorporates the subject matter of Examples 21-24. In this example, the computer readable medium includes instructions to synchronize a video data transfer start to a display internal refresh start.

Example 26 incorporates the subject matter of Examples 21-25. In this example, the computer readable medium includes instructions to resume a video data transfer.

Example 27 incorporates the subject matter of Examples 21-26. In this example, the burst of video data to be sent via the source interface controller of a central processing unit (CPU).

Example 28 incorporates the subject matter of Examples 21-27. In this example, the computer readable medium includes instructions to the burst of video data to be sent via the source interface controller of a graphics processing unit (GPU).

Example 29 incorporates the subject matter of Examples 21-28. In this example, the computer readable medium includes instructions to receive an additional video data transfer request to resume receiving bursts of video data via the sink interface controller, the video data transfer start to be synchronized with a display internal refresh start.

Example 30 incorporates the subject matter of Examples 21-29. In this example, the computer readable medium includes instructions to dynamically change refresh rates.

Example 31 is a system for controlling refresh rates. The system includes means for sending a video transfer request packet, the sink interface controller to receive an acknowledge response and video burst in response to the request packet, the sink interface controller to send an acknowledge response to the video burst. The system also includes means for to receiving the video transfer request packet and send an acknowledge response packet to the first module, the display controller to also send the video burst and receive a second acknowledge response packet.

Example 32 incorporates the subject matter of Example 31. In this example, the video burst includes video data to be sent at a full speed of a physical layer link.

Example 33 incorporates the subject matter of Examples 31-32. In this example, the first module further includes means for receiving the video burst from the sink interface controller and send it to a display device.

Example 34 incorporates the subject matter of Examples 31-33. In this example, the sink interface controller further includes a means for receiving the video burst from the display controller and send it to a display device.

Example 35 incorporates the subject matter of Examples 31-34. In this example, the display controller to send a video burst via the source interface controller of a central processing unit (CPU).

Example 36 incorporates the subject matter of Examples 31-35. In this example, the display controller to send a video burst via the source interface controller of a graphics processing unit (GPU).

Example 37 incorporates the subject matter of Examples 31-36. In this example, the system includes a mobile device.

Example 38 incorporates the subject matter of Examples 31-37. In this example, the display controller to send a video burst via the source interface controller of a central processing unit (CPU).

Example 39 incorporates the subject matter of Examples 31-38. In this example, the display controller to send a video burst via the source interface controller of a graphics processing unit (GPU).

Example 40 incorporates the subject matter of Examples 31-39. In this example, the system includes a mobile device.

Example 41 is an apparatus for controlling refresh rates. The apparatus includes a sink interface controller to send a video transfer request packet, the sink interface controller to receive an acknowledge response packet and a burst of video data in response to the video transfer request packet, the sink interface controller to send an acknowledge response to receiving the burst of video data. The apparatus also includes a timing controller to manage a refresh rate of the apparatus.

Example 42 incorporates the subject matter of Example 41. In this example, the frame buffer to store frames used in a panel self-refresh (PSR).

Example 43 incorporates the subject matter of Examples 41-42. In this example, the sink interface controller further includes a FIFO buffer.

Example 44 incorporates the subject matter of Examples 41-43. In this example, the sink interface controller to receive bursts of video data and store the bursts in the FIFO buffer, the FIFO buffer communicatively coupled with the timing controller.

Example 45 incorporates the subject matter of Examples 41-44. In this example, the sink interface controller further includes a line buffer.

Example 46 incorporates the subject matter of Examples 41-45. In this example, the sink interface controller further includes output laches.

Example 47 incorporates the subject matter of Examples 41-46. In this example, the acknowledge response packet including a refresh completion notification when a frame of video data has been received.

Example 48 incorporates the subject matter of Examples 41-47. In this example, the acknowledge response packet including an error when the FIFO buffer is full.

Example 49 incorporates the subject matter of Examples 41-48. In this example, the sink interface controller to synchronize a video data transfer start to a display internal refresh start.

Example 50 incorporates the subject matter of Examples 41-49. In this example, the apparatus includes a display of a mobile device.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A system for controlling refresh rates, comprising:
a sink interface controller to send a video transfer request packet, the sink interface controller to receive an acknowledge response and video burst in response to the request packet, the sink interface controller to send an acknowledge response to the video burst; and
a display controller to receive the video transfer request packet and send an acknowledge response packet to the first module, the display controller to also send the video burst and receive a second acknowledge response packet.

2. The system of claim 1, the video burst comprising video data to be sent at a full speed of a physical layer link.

3. The system of claim 1, the first module further comprising a First In, First Out (FIFO) data buffer, the FIFO to receive the video burst from the sink interface controller and send it to a display device.

4. The system of claim 1, the sink interface controller further comprising a line buffer or output laches, the line buffer or output laches to receive the video burst from the display controller and send it to a display device.

5. The system of claim 1, the display controller to send a video burst via the source interface controller of a central processing unit (CPU).

6. The system of claim 1, the display controller to send a video burst via the source interface controller of a graphics processing unit (GPU).

7. The system of claim 1, the system comprising a mobile device.

8. A method for controlling refresh rates, comprising:
sending, via a sink interface controller, a video data transfer request packet, the data transfer request packet to include a refresh rate capability of the display device;
receiving, via the sink interface controller, an acknowledge response packet;
receiving, via the sink interface controller, a burst of video data; and
sending, via the sink interface controller, an acknowledge response packet in response to receiving the burst of video data.

9. The method of claim 8, the acknowledge response packet including a refresh completion notification when a frame of video data has been received.

10. The method of claim 8, further comprising receiving additional bursts of video data and sending an error response packet when a FIFO in the sink interface controller is full, the error response packet to suspend further burst video data transfer.

11. The method of claim 10, further comprising sending an additional video data transfer request packet when the FIFO is no longer full to resume the burst video data transfer.

12. The method of claim 8, further comprising receiving video frames from an internal frame buffer to display a static image.

13. The method of claim 12, further comprising sending an additional video data transfer request to resume receiving bursts of video data via the sink interface controller, the video data transfer start to be synchronized with a display internal refresh start.

14. The method of claim 8, further comprising dynamically changing refresh rates.

15. At least one computer readable medium for controlling refresh rates having instructions stored therein that, in response to being executed on a computing device, cause the computing device to:
receive, via a processor, a video data transfer request packet;
send, via the processor, an acknowledge response packet in response to the video data transfer request packet; and
send, via the processor, a burst of video data.

16. The at least one computer readable medium of claim 15, further comprising instructions to initialize a source controller interface.

17. The at least one computer readable medium of claim 16, further comprising instructions to negotiate a data size of the burst of video data.

18. The at least one computer readable medium of claim 15, further comprising instructions to sleep for a predetermined interval of time based on a target refresh rate.

19. The at least one computer readable medium of claim 15, further comprising instructions to synchronize a video data transfer start to a display internal refresh start.

20. The at least one computer readable medium of claim 15, further comprising instructions to resume a video data transfer.

21. An apparatus for controlling refresh rates, comprising:
a sink interface controller to send a video transfer request packet, the sink interface controller to receive an acknowledge response packet and a burst of video data in response to the video transfer request packet, the sink interface controller to send an acknowledge response to receiving the burst of video data; and
a timing controller to manage a refresh rate of the apparatus.

22. The apparatus of claim 21, the timing controller further comprising a frame buffer, the frame buffer to store frames used in a panel self-refresh (PSR).

23. The apparatus of claim 21, the sink interface controller further comprising a FIFO buffer.

24. The apparatus of claim 23, the sink interface controller to receive bursts of video data and store the bursts in the FIFO buffer, the FIFO buffer communicatively coupled with the timing controller.

25. The apparatus of claim 23, the sink interface controller further comprising a line buffer or output laches.
